(19) United States
(12) Patent Application Publication
(10) Pub. No.: US 2009/0127357 A1
(43) Pub. Date: May 21, 2009

(54) ELECTROSTATICALLY ATOMIZING DEVICE AND FOOD CONTAINER PROVIDED WITH THE SAME

(76) Inventors: Hiroshi Suda, Takatsuki-shi (JP); Takayuki Nakada, Hikone-shi (JP); Masaharu Machi, Shijonawate-shi (JP)

Correspondence Address: Cheng Law Group, PLLC, 1100 17th Street, N.W., Suite 503, Washington, DC, 20036, US

(21) Appl. No.: 12/096,353

(22) PCT Filed: Dec. 19, 2006
(86) PCT No.: PCT/JP2006/325250

§ 371 Date: Jun. 5, 2008

(30) Foreign Application Priority Data
Dec. 22, 2005 (JP) 2005-371055

(51) Int. Cl. B05B 5/00; B65D 6/28

(52) U.S. Cl. 239/704; 220/608

(57) ABSTRACT

The liquid is supplied to an emitter electrode which is provided at a tip of a liquid carrier, receives a high voltage, is electrical-charged, and discharged as a mist of charged minute water particles of nanometer order from the emitter electrode. The emitter electrode discharges the mist of the charged minute water particles of micron order at the same time by a pressure which is applied to the liquid which is supplied to the tip of the emitter electrode. An electrostatically atomizing device supplies liquid to an emitter electrode of a tip of a liquid carrier, applies the high voltage to the liquid, electrically-charges the liquid, and causes the emitter electrode to discharge a mist of charged minute water particles of nanometer order. In addition, the electrostatically atomizing device applies a pressure to the emitter electrode and causes the emitter electrode to discharge a mist of the charged minute water particles of micron order. The electrostatically atomizing device is able to humidify a space by the mist of the charged minute water particles of micron order as well as is able to decompose harmful substances in the space, is able to sterilize and deodorize the substances in the space by radicals which is included by the mist of the charged minute water particles of nanometer order.

### TECHNICAL FIELD

This innovation relates to an electrostatically atomizing device which has a function of an efficient humidification as well as functions of a sterilization, a deodorization, and a efficient decomposition of a harmful substance, and a food container which incorporates the electrostatically atomizing device.

### BACKGROUND ART

Japanese patent application no. 2005-131549A discloses an electrostatically atomizing device which generates a mist of charged minute water particles by a method to atomize water electrically. The electrostatically atomizing device causes the Rayleigh breakup to the water of the emitter electrode, atomizes the water by the Rayleigh breakup, and then generates the mist of the charged minute water particles of nanometer order. The mist of the charged minute water particles includes radicals, is able to float in air over an extended time period, and is able to spread into the air in large quantity. The mist of the charged minute water particles adheres to substances of space where the mist of the charged minute water particles is discharged, penetrates the substances, and subsequently sterilizes and deodorizes the substances. The mist of the charged minute water particles is able to humidify the space. However, the mist of the charged minute water particles has diameters of the nanometer order. Even after the electrostatically atomizing device generates a large amount of the mist of the charged minute water particles of the nanometer order, the electrostatically atomizing device discharges only a little water. The electrostatically atomizing device is not able to sufficiently humidify the space. In the case of using the electrostatically atomizing device in the space where the humidification is required, the electrostatically atomizing device is generally used with a traditional humidifier which generates water vapor.

### DISCLOSURE OF THE INVENTION

In view of the above problem, the present invention is achieved to provide an electrostatically atomizing device which is capable of humidifying the space as well as decomposing the harmful substances, sterilizing the substances, and deodorizing the substances in the space, and to provide a food container which incorporates the electrostatically atomizing device.

The electrostatically atomizing device in accordance with the present invention includes a liquid carrier formed at its one end with an emitter electrode, an opposed electrode disposed in an opposed relation to the emitter electrode, a liquid supplying means for supplying a liquid to the liquid carrier, and a high voltage source configured to apply a high voltage between the emitter electrode and the opposed electrode to electrically-charge the liquid fed to a tip of the emitter electrode for discharging a mist of charged minute water particles from the tip of the emitter electrode. The liquid supplying means includes a pressurizing means configured to apply a pressure to the liquid on the emitter electrode for discharging from the tip of the emitter electrode the mist of the charged minute water particles of a size in a wide range from a nanometer order of 3 nm to 100 nm to a micron order of 0.1 μm to 10 μm. The high voltage source applies the high voltage at the tip of the emitter electrode. The high voltage of the tip of the emitter electrode forms a Taylor cone which is formed by the surface tension and at the tip of the emitter electrode. The high voltage of the tip of the emitter electrode causes a concentration of the electric charge at a tip of the Taylor cone and causes the water to break up. As a result, the mist of the charged minute water particles of the nanometer order is mainly generated and is discharged. In addition, the Taylor cone which is formed by the surface tension receives the pressure by the pressurizing means. The pressure upsets the balance of the form of the Taylor cone which is formed by the surface tension. For this reason, the liquid of some parts other than the tip of the Taylor cone also breaks up. And then, the mist of the charged minute water particles is generated from the some parts other than the tip of the Taylor cone. The electrically-charge is hardly concentrated at the tip of the Taylor cone. As a result, the liquid has little energy for breaking up. Consequently, the mist of the charged minute water particles of micron order is generated from the some parts other than the tip of the Taylor cone. In this case, the electrostatically atomizing device is able to humidify the space by the mist of the charged minute water particles of micron order which is discharged with the mist of the charged minute water particles of nanometer order as well as is able to decompose the harmful substances in the space, and is able to sterilize and deodorize the substances in the space by the mist of the charged minute water particles of nanometer order.

Preferably, the liquid carrier is of a tubular configuration composed of a main tube and a capillary tube which extends from the main tube and which defines the emitter electrode. The main tube has an inside diameter sufficiently larger than that of the capillary tube so as to cause no capillary action. The main tube is provided at its rear end with a pressurizing tank which defines the liquid supplying means such that the liquid stored in the pressurizing tank applies the pressure to the liquid at the tip of the capillary tube. In this way, the emitter electrode of the electrostatically atomizing device generates the mist of the charged minute water particles of nanometer order and the mist of the charged minute water particles of micron order. With this arrangement, the pressurizing tank is able to apply a suitable pressure to the liquid which is supplied to the emitter electrode by the capillary action and which is held at the tip of the emitter electrode. Consequently, the emitter electrode of the electrostatically atomizing device is able to generate the mist of the charged minute water particles on nanometer order and micron order.

In the case of configuring the pressurizing tank to apply a water head pressure of the stored liquid to the liquid at the tip of the capillary tube, it is preferable that a replenishing tank is coupled to the pressurizing tank, and a level sensor is configured to detect a liquid level of the liquid in the pressurizing tank, and a replenishing means is configured to add the liquid from replenishing tank to the pressurizing tank in order to keep the liquid level detected by the level sensor at a constant level. In this case, the pressuring tank is able to apply a constant water head pressure to the liquid at the tip of the emitter electrode. As a result, the emitter electrode of the electrostatically atomizing device is able to generate the mist of the charged minute water particles of nanometer order and micron order which have stable particle size distribution.

Furthermore, it is also preferable that the pressurizing tank includes a piston for pressurizing the liquid. In this case, the pressuring tank is able to apply the pressure to the liquid by using the piston without using the replenishing tank. Consequently, the emitter electrode of the electrostatically atomizing device is able to generate the mist of the charged minute water particles of stable particle size distribution.

It is preferable that the mist of the charged minute water particles of the size in the nanometer order exhibits a particle size distribution having a peak at 3 nm to 50 nm, and the mist of the charged minute particles of the size in the micron order exhibits a particle size distribution having a peak at 0.5 μm to 1.5 μm. The mist of the charged minute water particles of nanometer order and micron order having previously described particle size distributions are able to sufficiently humidify the space as well as is able to decompose the harmful substances, sterilize the substances, and deodorize the substances in the space. Especially, in the case of using the electrostatically atomizing device of the present invention for a vegetable compartment of the container, the mist of the charged minute water particle of micron order having the above mentioned particle size distribution penetrates an inside of vegetables through the vegetable stomata of 100-200 μm long and 10μm wide, supplies the water to the vegetables, and keeps the vegetable fresh. In addition, the mist of the charged minute water particles of nanometer order decomposes the harmful substances such as agrichemical which adheres to the vegetables, sterilizes the vegetable, and deodorizes the vegetable. Furthermore, the mist of the charged minute water particles of micron order which has the peak of the particle size distribution of 0.5 μm to 1.5 μm is able to supply the water to various vegetables efficiently. The above mentioned particle size distribution is able to adjust by varying the pressure. Consequently, it is preferable that a pressure regulating means is provided to regulate the pressure applied to the liquid by the pressurizing means.

In addition, it is preferable that the liquid carrier includes a filter configured to entrap mineral components contained in the liquid. In the case of using tap water as the liquid, the filter entraps the mineral components such as Ca and Mg, and prevents the mineral components from depositing to the emitter electrode. Consequently, the emitter electrode is able to electrostatically atomize.

Preferably, the electrostatically atomizing device is arranged in the food container. The previous described food container is able to humidify the food of the inside of the food container and is able to keep the foods fresh by the mist of the charged minute water particles of micron order as well as is able to decompose the harmful substances, sterilize foods, and deodorizing the foods in the food container by the mist of the charged minute water particles of nanometer order.

### BRIEF DESCRIPTION OF THE DRAWING

FIG. 1 shows a schematic view of an electrostatically atomizing device in accordance with an embodiment of the present invention,

FIG. 2 shows a perspective view of the above electrostatically atomizing device,

FIG. 3 shows a perspective view of the above electrostatically atomizing device in the state that the cover is removed,

FIG. 4 shows a schematic view of an electrostatically atomizing device in accordance with another embodiment of the present invention,

FIG. 5 shows a schematic view of a food container provided with the electrostatically atomizing device in accordance with the present invention, and

FIG. 6 shows the graph explaining a preservation of a freshness of leafy vegetables in using the electrostatically atomizing device in accordance with the present invention.

### BEST MODE FOR CARRYING OUT THE INVENTION

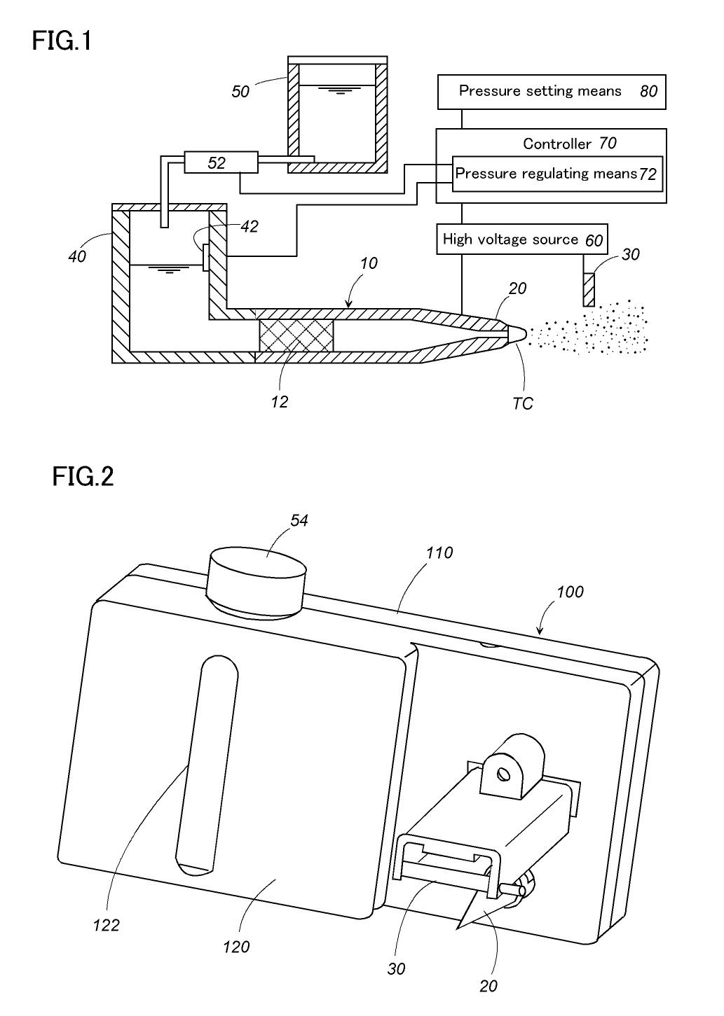

Now a reference is made to the attached drawings to explain an electrostatically atomizing device in accordance with one embodiment of the present invention. As shown in FIG. 1, the electrostatically atomizing device includes a liquid carrier 10 which is formed at its one end with an emitter electrode 20, an opposed electrode 30, a high voltage source 60, and a controller 70. The opposed electrode 30 is disposed in an opposed relation to the emitter electrode 20. The high voltage source 60 is provided in order to apply a high voltage between the emitter electrode 20 and the opposed electrode 30. The controller 70 is configured to control a high voltage value of the applied high voltage. The liquid carrier 10 has a rear end which is connected to a pressuring tank 40. The pressuring tank 40 supplies a liquid which is stored in the pressuring tank such as water to the one end of the emitter electrode through the liquid carrier 10. The pressuring tank 40 defines the liquid supplying means for supplying the liquid to the liquid carrier 10 and the pressurizing means for applying the pressure to the liquid. The electrostatically atomizing device of this embodiment is explained by using the water as the liquid. However, the electrostatically atomizing device of this invention also is able to use the liquid other than the water.

The water is supplied to the emitter electrode and forms a ball of the water at the tip of the emitter electrode by a surface tension. The high voltage source applies the high voltage such as −8 kV to the emitter electrode 20 and generates the high voltage electric field between the opposed electrode 30 and the discharge end of the emitter electrode. The high voltage electric field electrically-charges the water by the static electrical charge and causes the emitter electrode 20 to discharge the mist of the charged minute water particles M. The high voltage which is applied between the emitter electrode 20 and the opposed electrode 30 generates the Coulomb force between the opposed electrode 30 and the water which is held at the one end of the emitter electrode, thereby forming the Taylor cone TC which protrudes from the surface of the ball of the water. Then, the electric charge concentrates to the tip of the Taylor cone TC. The electric field intensity of the tip of the Taylor cone becomes larger. As the electric field intensity of the tip of the Taylor cone becomes larger, the Coulomb force of the tip of the Taylor cone becomes larger, thereby developing the large Taylor cone TC. When the Coulomb force becomes larger than the surface tension of the water W, the Taylor cone repeats the breakup (Rayleigh breakup). As a result, a large amount of the mist of the charged minute water particles of nanometer order is generated. The mist of the charged minute water particles of nanometer order is carried by an airflow which is caused by an ion wind which flows from the emitter electrode 20 to the opposed electrode 30, and is discharged through the opposed electrode 30.

The pressuring tank 40 is supplied with the water from a replenishing tank 50 by a pump 52. A water level of the pressuring tank 40 is always controlled to a same water level. The pressuring tank which is kept to keep a same water level applies a constant water head pressure to the one end of the emitter electrode 20. For this reason, the pressuring tank 40 is provided with a level sensor 42. The pump 52 is controlled by a pressure regulating means 72, thereby keeping the water level which is sensed by the level sensor 42 to the constant water level. The pressure regulating means 72 constitutes the controller 70 and controls the pump 52 to generate a pressure value, namely the water head pressure which is configured by a pressure setting means 80.

The liquid carrier 10 is a the tubular configuration. The liquid carrier 10 is formed at its one end with the emitter electrode 20 which is formed into a capillary tube. The some parts of the liquid carrier 10 across the pressuring tank 40 and the emitter electrode 20 is formed to have an inner diameter which does not take place the capillary action. Thus, the water head pressure is applied to the ball of the water which is formed at the emitter electrode 20. The inner diameter of the liquid carrier 10 gradually becomes smaller toward its one end which is the capillary tube. The water is supplied to the tip of the emitter electrode through the capillary tube and forms the ball of the water at the tip of the emitter electrode by the surface tension. The water head pressure is controlled not to prevent the surface tension from forming the ball of the water. The water head pressure is applied to the Taylor cone TC which is formed by the high voltage.

The water head pressure is applied to the Taylor cone TC which has the form kept by the surface tension. By applying the high voltage, the some parts other than the tip of the surface of the Taylor cone where the electric-charge is concentrated is also breakup. The amount of the electric-charge of the some parts other than the tip of the Taylor cone is lessen than the amount of the electric-charge at the tip of the Taylor cone. The some parts other than the tip of the Taylor cone have a little energy to break up the water. As a result, it is considered that the mist of the charged minute water particles of micron order is mainly generated. Consequently, by applying the high voltage to the water which is held at the tip of the emitter electrode 20 and which receives the pressure, the mist of the charged minute water particles of nanometer order is generated from the tip of the Taylor cone TC. And, the mist of the charged minute water particles of micron order is generated from the some parts other than the tip of the Taylor cone TC. The mists of the charged minute water particles of nanometer order and micron order are discharged to the space in the diffused state. The emitter electrode 20 continues being supplied with the water by the pressure, and generates the mist of the charged minute water particles continuously.

The mist of the charged minute water particles of nanometer order includes radicals. The radicals decomposes the harmful substances, sterilizes the substances in the space, and deodorizes the substances in the space. The mist of the charged minute water particles of micron order spreads into the space and humidifies the space.

The pressure regulating means 72 varies the pressure for applying the emitter electrode 20, thereby adjusting the particle size distribution and the generation amount of the mists of the charged minute water particles of nanometer order and micron order. Namely, according to the pressure which is configured by the pressure setting means 80, the particle size distribution and a ratio of the generation amount is able to select. The emitter electrode 20 is able to generate a mixture mist which includes optimum quantities of the mists of the charged minute water particles of nanometer order and micron order as usage.

In this application, the nanometer order is defined in a range which is equal to or more than 3 nm and is equal to or less than 100 nm. The micron order is defined in a range which exceeds 0.1 μm and is equal to or less than 10 μm.

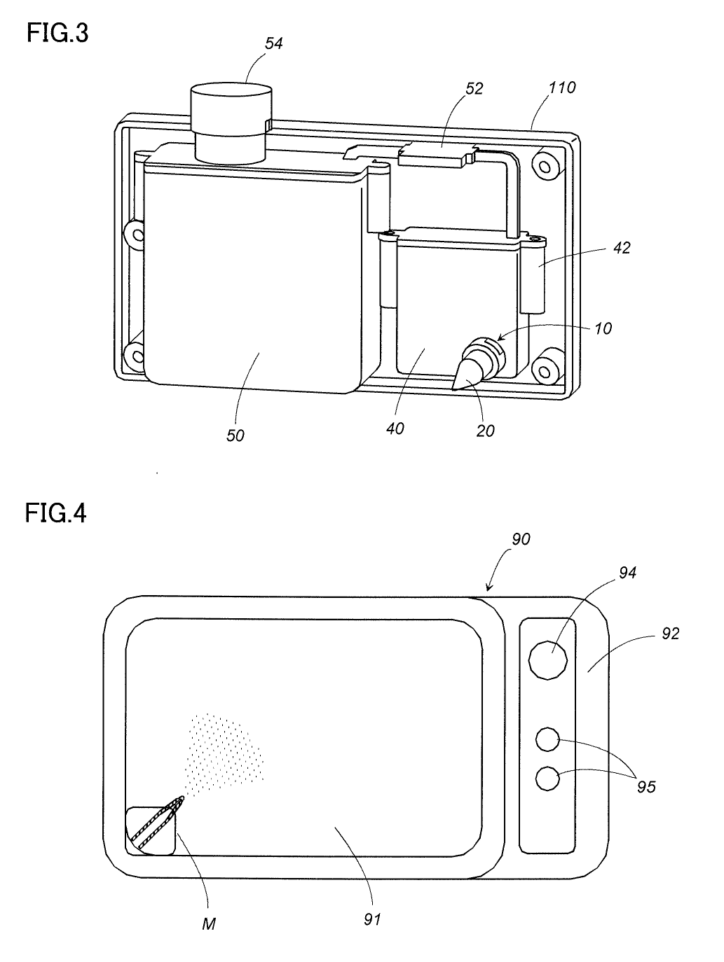

The above mentioned parts which constitute the electrostatically atomizing device are incorporated into a housing 100 which is shown in FIG. 2 and FIG. 3. The housing 100 includes a base 110 and a cover 120 which covers the base 110. The base 110 holds the liquid carrier 10 which is integrated with the pressuring tank 40, the replenishing tank 50, and the pump 52. The cover 120 holds the opposed electrode 30. An outside surface of the housing 100 is provided with the emitter electrode 20 and the opposed electrode 30. The housing 100 incorporates electrical parts which constitutes the high voltage source 60, the controller 70, and the pressure setting means 80. The cover 120 is provided with a window 122. The window 122 is provided in order to check the water level of the replenishing tank 50 which is made of a transparent material. The replenishing tank 50 is provided with the cap 54 and is supplied with the water according to need.

In the electrostatically atomizing device in accordance with the present invention, the liquid carrier 10 is provided with the filter 12 which entraps mineral components such as Ca and Mg. In this way, the filter 12 prevents the mineral components from depositing to the emitter electrode 20 when the tap water is used to the electrostatically atomizing device.

FIG. 4 shows the electrostatically atomizing device which is incorporated into the food container 90 which stores the foods such as the vegetables. The food container 90 is able to decompose the harmful substances such as agrichemicals, sterilize the foods, and deodorize the foods by the mist of the charged minute water particles of nanometer order. The food container 90 is able to maintain the suitable humidity in an inside space of the food container 90 by the mist of the charged minute water particles of micron order. Especially in the case of storing the vegetables in the food container, a large amount of the charged minute water particles of micron order are supplied to the vegetables tissue through the stomata of the vegetables. In this way, the food container is able to keep the vegetables fresh.

The food container 90 is provided with a temperature regulator 92 for keeping a predetermined temperature. An outside surface of the temperature regulator 92 is provided with a power button 94 and a temperature regulating button 95. The electrostatically atomizing device M is operated by the power button 94 and discharges the mists of the charged minute water particles of nanometer order and micron order to a container 91.

It is known that the leafy vegetables are not able to keep its freshness by only supplying the water to a surface of a leaf but is able to keep its freshness by supplying the water to the tissues of the leaf through the stomata of the leaf. The stomata of the leaf of the leafy vegetables are about 100-200 μm long and about 10 μm wide. Because the mist of the charged minute water particles of nanometer order has extremely small particle diameter, the mist of the charged minute water particles of nanometer order penetrates into the tissues of the leaf through the stomata of the leaf, but is not able to supply the necessary water to the leafy vegetables for keeping the leafy vegetables fresh. However, the mist of the charged minute water particles of micron order has large amount of the water than that of nanometer order. The charged minute water particles of micron order is able to penetrate to the tissue of the leaf through the stomata of the leaf, is able to supply a sufficient amount of the water to the tissue of the leafy vegetables, and is able to keep the leafy vegetables fresh. For this reason, the electrostatically atomizing device which is incorporated into the food container is adjusted to the suitable pressure and the suitable applied voltage for generating the mist of the charged minute water particles of micron order which has a peak of the particle size distribution in a range which is equal to or less than 10 μm (preferably, is equal to or more than 0.5 μm and is equal to or less than 1.5 μm).

In addition, the mist of the charged minute water particles of nanometer order is able to penetrate into the tissue of the leafy vegetables through the stomata, is able to decompose the harmful substances such as the agrichemicals which penetrates to an inside of the tissues of the leafy vegetables, is able to sterilize and deodorize the inside of the tissues of the leafy vegetables as well as is able to decompose the harmful substances which adhere to the leafy vegetables, is able to sterilize the leafy vegetables, and is able to deodorize the leafy vegetables. In this case, the pressure and the applied voltage is adjusted for generating the mist of the charged minute water particles of nanometer order which has the particle size distribution in a range which is equal to or more than 3 nm and is equal to or less than 50 nm.

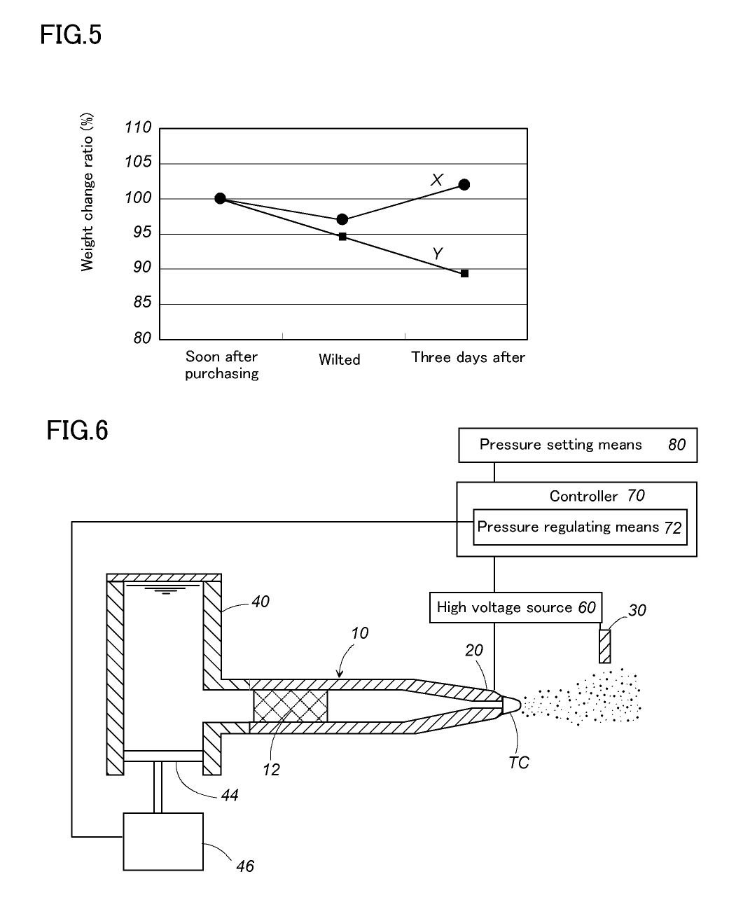

FIG. 5 shows a freshness keeping effect (activity effect) of the leafy vegetables in the food container which incorporates the above mentioned electrostatically atomizing device. In this experience, a stick of wilted celery was prepared as a sample and was put in the container 91 which was a 30 liter in volume. The inside of the container 91 was illuminated into a blue LEDs as a dummy sunlight, was kept at 5 degrees Celsius, and was kept at a humidity of 99%. The electrostatically atomizing device M discharged the mist of the charged minute water particles of nanometer order and micron order to the container 91 by applying the 8 kV between the emitter electrode 20 and the opposed electrode 30. The generation amount of the mist of the charged minute water particles was 2 g per an hour. A curve X of FIG. 5 shows a weight change ratio of a stick of the wilted celery which was placed in the container 91 for three days. The weight change ratio of a stick of the wilted celery increases to the 102%. And the freshness of the celery is kept. Meanwhile, the curve Y of the FIG. 5 shows an experience of using the above mentioned food container 90 without driving the electrostatically atomizing device. In this case, the weight change ratio of the celery three days after decrease to 89%, and the celery becomes more wilted and loses the freshness.

In addition, the experimentation of a decomposition of the agrichemicals from the leafy vegetables was conducted in the above mentioned food container. In this experience, the petri dish storing the fenitrothion (MEP 1 ppm, 0.1 ml) as one example of the agrichemicals was placed at the container 91 which was 30 liter volume. The inside of the container 91 was illuminated by the blue LEDs as the dummy sunlight. The electrostatically atomizing device M discharged the mists of the charged minute water particles of nanometer order and micron order to the container 91 by applying 8 kV between the emitter electrode 20 and the opposed electrode 30. The generation amount of the mist of the charged minute water particles was 2 g per an hour. As a result, the removal ratio of the agrichemicals after 24 hours was 44%. Consequently, it became apparent that the mist of the charged minute water particles had a good removal effect of the agrichemicals. Besides an amount of the radicals generated by the electrostatically atomizing device is 12 μM/L.

FIG. 6 shows another embodiment of the electrostatically atomizing device in accordance with the present invention. In this embodiment, the electrostatically atomizing device is provided with a piston 44 which is used as the pressurizing means. For this reason, the other configurations and operations are similar to the above embodiment, and duplicate explanations are omitted. The piston 44 is arranged at the pressuring tank 40 which is formed at a rear end of the liquid carrier 10. The piston 44 is driven by an actuator 46, and applies the pressure to the water which is supplied to the liquid carrier 10 from the pressuring tank 40. The actuator 46 is controlled by the pressure regulating means 72, generates the pressure which is selected by the pressure setting means 80, and applies the pressure to the Taylor cone TC which is formed at the tip of the emitter electrode 20. In this embodiment, the pressuring tank 40 is defined as the liquid supplying means and the piston is defined as the pressurizing means.

1. An electrostatically atomizing device comprising:
a liquid carrier formed at its one end with an emitter electrode;
an opposed electrode disposed in an opposed relation to said emitter electrode;
a liquid supplying means for supplying a liquid to said liquid carrier;
a high voltage source configured to apply a high voltage between said emitter electrode and said opposed electrode to electrically-charge the liquid fed to a tip of said emitter electrode for discharging a mist of charged minute particles from the tip of said emitter electrode;
wherein said liquid supplying means includes a pressurizing means configured to apply a pressure to the liquid on said emitter electrode for discharging the mist of the charged minute particles of a size in a wide range between a nanometer order of 3 nm to 100 nm and a micron order of 0.1 μm to 10 μm from the tip of said emitter electrode.

2. An electrostatically atomizing device as set forth in claim 1, wherein said liquid carrier is of a tubular configuration composed of a main tube and a capillary tube which extends from said main tube and which defines said emitter electrode, said main tube having an inside diameter sufficiently larger than that of said capillary tube so as to cause no capillary action, said main tube being provided at its rear end with a pressurizing tank which defines said liquid supplying means such that the liquid stored in said pressurizing tank applies the pressure to the liquid at the tip of said capillary tube.

3. An electrostatically atomizing device as set forth in claim 2, wherein said pressurizing tank is configured to apply a water head pressure of the stored liquid to the liquid at the tip of said capillary tube.

4. An electrostatically atomizing device as set forth in claim 3, further including:
a replenishing tank coupled to said pressurizing tank; and
a level sensor configured to detect a liquid level of the liquid in said pressurizing tank; and
a replenishing means configured to add the liquid from said replenishing tank to said pressurizing tank in order to keep the liquid level detected by said level sensor at a constant level.

5. An electrostatically atomizing device as set forth in claim 2, wherein said pressurizing tank includes a piston for pressurizing the liquid.

6. An electrostatically atomizing device as set forth in claim 1, wherein said mist of the charged minute particles of the size in the micron order exhibits a particle size distribution having a peak at 0.5 μm to 1.5 μm.

7. An electrostatically atomizing device as set forth in claim 1, wherein said mist of the charged minute particles of the size in the nanometer order exhibits a particle size distribution having a peak at 3 nm to 50 nm, and said mist of the charged minute particles of the size in the micron order exhibits a particle size distribution having a peak at 0.5 μm to 1.5 μm.

8. An electrostatically atomizing device as set forth in claim 1, wherein a pressure regulating means is provided to regulate the pressure applied to the liquid by said pressurizing means.

9. An electrostatically atomizing device as set forth in claim 1, wherein said liquid carrier includes a filter configured to entrap mineral components contained in the liquid.

10. A food container provided with the electrostatically atomizing device as defined in claim 1.

11. A food container provided with the electrostatically atomizing device as defined in claim 2.

12. A food container provided with the electrostatically atomizing device as defined in claim 3.

13. A food container provided with the electrostatically atomizing device as defined in claim 4.

14. A food container provided with the electrostatically atomizing device as defined in claim 5.

15. A food container provided with the electrostatically atomizing device as defined in claim 6.

16. A food container provided with the electrostatically atomizing device as defined in claim 7.

17. A food container provided with the electrostatically atomizing device as defined in claim 8.

18. A food container provided with the electrostatically atomizing device as defined in claim 9.
